(19) United States
(12) Patent Application Publication
(10) Pub. No.: US 2009/0164362 A1
(43) Pub. Date: Jun. 25, 2009

(54) System and Method for Funding Loans

(76) Inventor: Ronald Moore, Frisco, TX (US)

Correspondence Address: CASH KLEMCHUK POWERS TAYLOR LLP, CAMPBELL CENTRE II, 8150 NORTH CENTRAL EXPRESSWAY, SUITE 1575, DALLAS, TX, 75206, US

(21) Appl. No.: 11/960,421

(22) Filed: Dec. 19, 2007

(51) Int. Cl. G06Q 40/00

(52) U.S. Cl. 705/38; 705/35

(57) ABSTRACT

The problems presented in loan funding industry are solved by the systems and methods of the present invention. In accordance with one embodiment of the present invention, a system is provided where a borrower applies for and is approved for a loan remotely after which the borrower is provided with data, the borrower then enters the provided data into an automated teller machine and the automatic teller machine verifies the amount to be dispersed and disperses the amount to be lent to the borrower.

### BACKGROUND

1. Field of the Invention

The present invention relates generally financial transactions and in particular to loan funding.

2. Description of Related Art

Within the lending industry, and in particular within the payday loan market, loans are funded under very controlled and often time-consuming methods.

For borrowers who have credit ratings that prevent them from getting credit cards or debit cards, the only similar loans are generally referred to as “payday loans.” Payday loans are typically short-term loans meant to bridge a financial gap with a duration of less than two weeks and in an amount less than the borrower's next paycheck.

The common payday loan requires the borrower to approach a storefront and apply for the loan. This requires the filling out of an application form, the provision of a government issued ID, a recent pay stub, a recent utility bill from the current home address and a post-dated check for the amount of the loan plus any fees. If approved, the lender will retain the post-dated check. The lender then hands the borrower the amount of the loan in cash. Pay back for the loan is accomplished by depositing the post dated check or through an authorized ACH transaction.

One problem with this arrangement is that many storefronts that offer this service are concentrated in poor neighborhoods and tend to attract crime against the storefront as well as the borrowers. Therefore, there has been some movement to online, fax, and telephone transactions to avoid the storefront dispensing of cash. The primary problem with these transactions is the funding of the loan. The money may be deposited into the borrowers' checking account by an ACH transaction, but that takes at least 24 hours and will not be processed after 5:00 PM or over the weekend. This means that some loans may take up to 48 hours to fund and a loan processed over the weekend will not fund until the next Tuesday. Other alternatives are available for funding loan including funding a pre-paid debit card account, wire transfer and money transfer. In these cases, the funding of consumer can be processed within minutes of approval of transaction. However, each of these methods will generate an additional expense to fund the loan for the lender that break into the revenue margins and make the transaction less attractive. Some of the lenders will pass the additional cost to the consumer (about $25-$50 for wire transfer, about $10-$30 for money transfer, and about $2.50-$10.00 for loan on pre-paid card, all passed on to the consumer).

Pre-paid cards are popular because of the wide distribution of the existing ATM networks. A pre-paid card allows the borrower access to their loan at multiple locations, depending on the network being used. This allows far more mobility for the borrower than the other funding mechanisms. The primary problem with the pre-paid card is that the physical card must be delivered to the borrower. This initial wait may frustrate first time borrowers. Further, once a pre-paid card has been drained of loaded value it may be discarded or misplaced, thus requiring another wait time for return borrowers who do not maintain their cards.

It is important to understand at this point the basic processes used by ATM processors. When a card is entered into an ATM the ATM processor first uses the Bank Identification Number, or BIN (typically the first 6 digits of a card's number), to determine if the transaction is within the ATM processor's system or outside it The BIN tells the ATM processor which bank issued the card and what network would be responsible for handling the transactions. If the transaction is within the ATM processor's system, the information is verified against a local database and the transaction is handled without reference to other lending processors or networks. If the transaction is outside the ATM processor's system, the consumer request is sent to a regional or national banking network based on the Bank Identification Number. The network will verify the necessary information and send instructions to the ATM processor.

A need exists, therefore, for a method and system for funding loans that is fast and low cost for all approved borrowers.

### BRIEF SUMMARY OF THE INVENTION

The problems presented in loan finding industry are solved by the systems and methods of the present invention. In accordance with one embodiment of the present invention, a system is provided where a borrower applies for and is approved for a loan remotely after which the borrower is provided with data, the borrower then enters the provided data into an automated teller machine and the automatic teller machine verifies the amount to be dispersed and disperses the amount to be lent to the borrower.

Other objects, features, and advantages of the present invention will become apparent with reference to the drawings and detailed description that follow.

### BRIEF DESCRIPTION OF THE DRAWINGS

FIG. 1 is a flow chart of an embodiment of a loan application process;

FIG. 2 is a flow chart of an embodiment of a loan acceptance process;

FIG. 3 is a flow chart of an embodiment of a loan funding process; and

FIG. 4 is a schematic depicting an embodiment of the funding system structure.

### DETAILED DESCRIPTION OF THE PREFERRED EMBODIMENT

All references cited herein are incorporated by reference to the maximum extent allowable by law. To the extent a reference may not be fully incorporated herein, it is incorporated by reference for background purposes and indicative of the knowledge of one of ordinary skill in the art.

In the following detailed description of the preferred embodiments, reference is made to the accompanying drawings that form a part hereof, and in which is shown by way of illustration specific preferred embodiments in which the invention may be practiced. These embodiments are described in sufficient detail to enable those skilled in the art to practice the invention, and it is understood that other embodiments may be utilized and that logical mechanical and electrical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

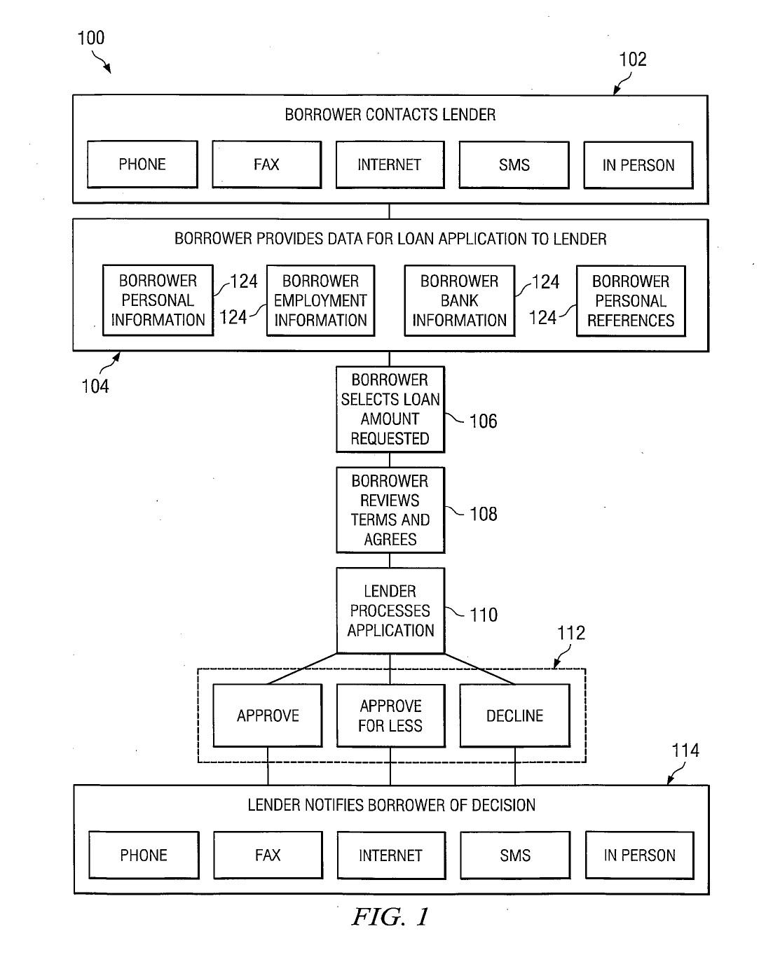

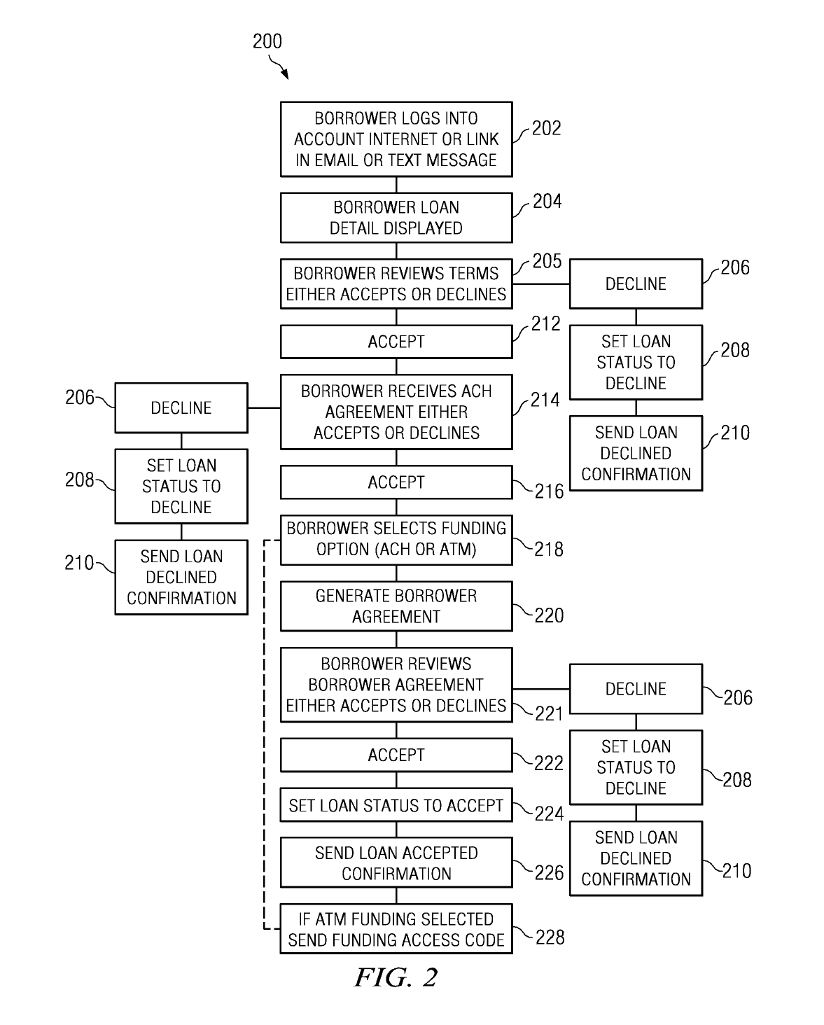

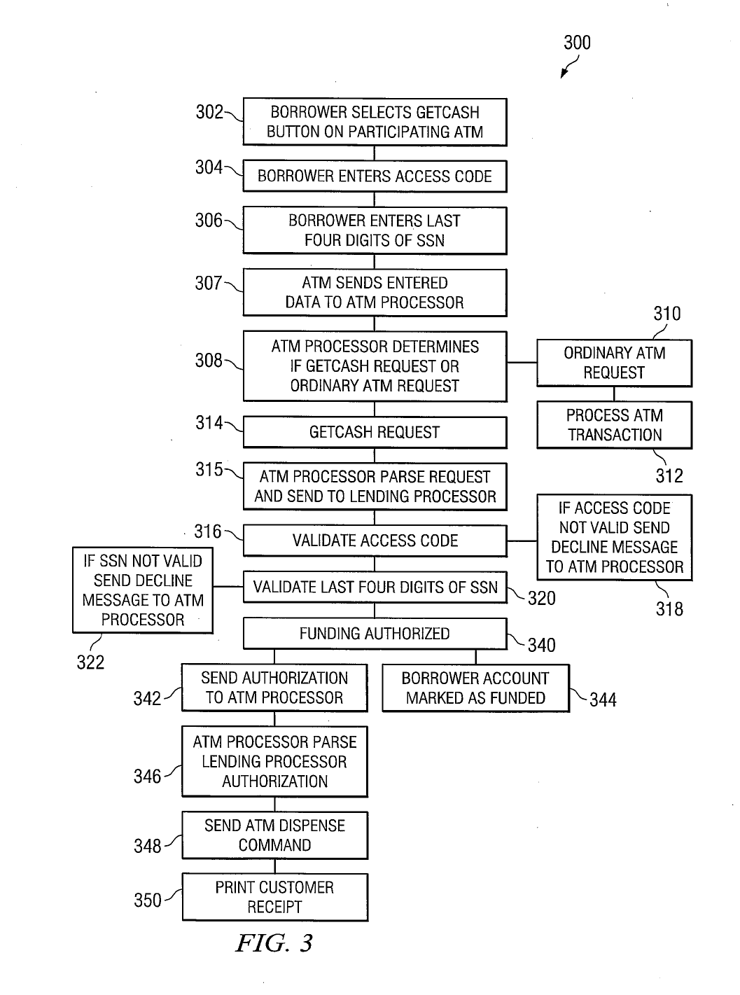

FIGS. 1-3 show the processes of an embodiment of the loan funding system 10, with FIG. 1 showing the loan application process 100, FIG. 2 the loan acceptance process 200 and FIG. 3 the loan funding process 300. The processes work together to form the loan funding system, although minor modifications to the processes can be made without deviating from the system 10.

FIG. 1 is a flow chart of an embodiment of a loan application process 100 of the loan funding system 10. The loan application process begins with a borrower 12 contacting a lender 14 as shown in step 102. This contact typically occurs via the world wide computer network commonly referred to as the internet or world wide web as borrower 12 points a browser to a web site connected with lender 14. The contact of step 102 may also occur over typical phone lines, fax, wireless text messaging (such as SMS), or even in-person or at a kiosk. Borrower must then provide data 124 for the loan application to the lender as shown in step 104. This data 124 will typically include personal, employment, and bank information relating to the borrower 12. This data 124 may also include the borrower's 12 personal references, including names and phone numbers. The personal information would include name, Social Security Number (SSN), driver license number, date of birth and contact information such as phone numbers and residential address. The employment information could include employer name, address, work phone number, monthly income, start date and pay period, and next two payday dates. The banking information could include all information necessary for the lender to schedule an ACH transfer from the borrower's account to the lender's account at the end of the loan period, such as bank name, bank routing number, bank account number, and type of account. In step 106, borrower 12 selects a loan amount to request from the lender 14 and in step 108 the borrower reviews and accepts the basic terms of the loan application.

The above steps have provided the lender data necessary for the lender 14 to process the application and determine whether to fund the requested amount, a lower amount, or to decline the loan request completely. Step 110 is the processing step and step 112 shows the results of the processing. In step 114, the lender 14 notifies the borrower 12 of the decision. In most cases this notification will be nearly automatic as the lender 14 may have automate verification and processing. In some cases, the data may not allow for automated processing and human intervention may slow the process down. Notice is sent via some means to the borrower that the loan has been approved, approved for less than requested, or declined.

FIG. 2 is a flow chart of an embodiment of a loan acceptance process 200 as is required if a loan has been approved in the loan application process 100. Loan approval process 200 is shown as an automated process using the computer network known generally as the internet or world wide web. The borrower 12 logs in to a borrower account on a web site associated with the lender 14 as shown in step 202 by either pointing a browser to the web site or activating a link in a message sent to borrower by some means such as email or text messaging. After logging in borrower 12 may choose to display loan details as shown in step 204. Borrower 12 may then review the terms of the loan and either accepts or declines as shown in step 205. If borrower 12 declines as shown in step 206, then the loan status is set to “decline” as shown in step 208 and a loan declined confirmation message is sent to borrower 12 as shown in step 210. A loan with a status of decline may not be funded. If borrower 12 accepts the terms as shown in step 212, then an ACH Agreement will be displayed for borrower 12 to review and either accept or decline as shown in step 214. If borrower 12 declines as shown in step 206 then the loan status is set to “decline” as shown in step 208 and a loan declined confirmation message is sent to borrower 12 as shown in step 210. If borrower 12 accepts as shown in step 216, borrower must then choose a funding option as shown in step 218. Typically the funding options will be either ACH or ATM, although other funding options known in the art, such as pre-paid cards or wire transfer, may be available as well. Once a funding option has been chosen, a borrower agreement may be generated as shown in step 220. Borrower 12 would then review the borrower agreement and either accept or decline as shown in step 221. If borrower 12 declines as shown in step 206, then the loan status is set to “decline” as shown in step 208 and a loan declined confirmation message is sent to borrower 12 as shown in step 210. If borrower 12 accepts the borrower agreement as shown in step 222, then the loan status is set to “accept” as shown in step 224 and a loan accepted confirmation message is sent to borrower as shown in step 226. If ATM funding was chosen in step 218, then a funding access code 232 is generated and sent to the borrower 12 as shown in step 228.

FIG. 3 is a flow chart of an embodiment of a loan funding process 300, which begins with the borrower 12 approaching a participating ATM and selecting the “GetCash” option as shown in step 302. Of course, the “GetCash” button may be any moniker sufficient to distinguish the following transaction from a normal ATM transaction, in important part providing a field for entering a access code 332 and some personal data 324, such as the last four digits of a social security number, as shown in steps 304 and 306 respectively. “GetCash” is used in this section as a shorthand for a payday loan transaction funded through an ATM without the use of a card. The ATM will format the entered data and send it to the ATM processor 338 as shown in step 307. If the ATM processor 338 determines in step 308 that the data is an ordinary ATM transaction as shown in step 310, then it will process accordingly as shown in step 312. If the ATM processor 338 determines in step 308 that the request is a “GetCash” transaction as shown in step 314, then the ATM processor 338 will parse the request and send the request to the lending processor 334 as shown in step 315. The lending processor 334 will validate the access code 332 as shown in step 316. If access code 332 is not valid, then the lending processor will send a decline message to the ATM processor as shown in step 318. If the access code 332 is valid, then the lending processor 334 will validate the personal information sent, such as the last four digits of the social security number as shown in step 320. If the personal information is not valid, then the lending processor 334 will send a decline message to the ATM processor 338 as shown in step 322. If the personal information is valid, then the lending processor 334 will authorize the funding as shown in step 340 thus sending a authorization to the ATM processor 338 as shown in step 342. The lending processor will also mark the borrower account as funded to prevent multiple fundings from one account as shown in step 344. After receiving the authorization from the lending processor 334, the ATM processor 338 will parse the lending processor authorization as shown in step 346 and send an ATM Dispense Command to the ATM as shown in step 348. The ATM may also print a customer receipt as shown in step 350.

Much of the communication above is not dependent on any particular infrastructure and will be adaptable to new infrastructures. For example, communications between ATMs, ATM processors, and the lending processor are all done in accordance with ISO8583 as it is currently implemented, but will likely change if there are advances in these types of communications.

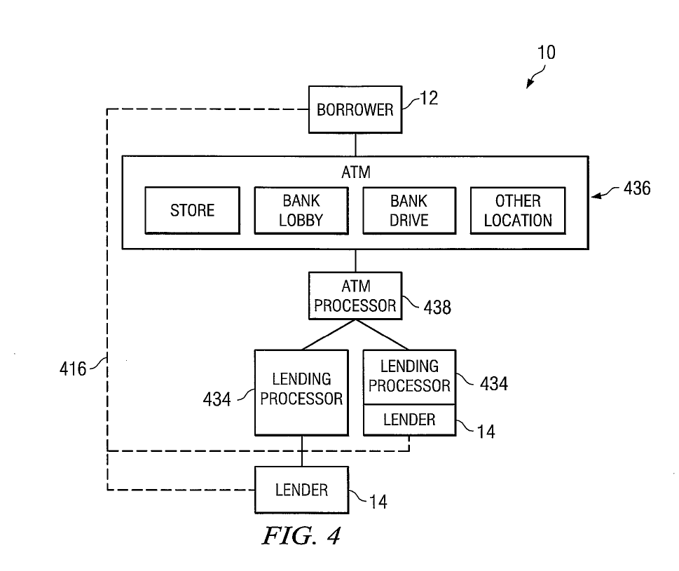

FIG. 4 is a schematic depicting an embodiment of the funding system 10 using existing ATM networks to fund loans without the requirement of a bank card. In this embodiment of the funding system 10 borrower 12 is borrowing money from lender 14. Borrower 12 and lender 14 can communicate via a remote communication link 416 such as a telephone, fax, wireless messaging (such as SMS text messaging), or computer network. The key is that borrower 12 need not be in the vicinity of lender 14 and vice versa. Borrower 12 will transmit borrower data 424 to lender 14.

Upon receipt of the borrower data 424, lender 14 must determine if a loan will be approved as described above. If approved, lender 14 creates a record 428 associating a loan amount 430 with an access code 432. Access code 432 must be a human readable data set, such as a string of alphanumeric data. Typically a string of numeric data, such as a 16 digit numeric code will be the access code 432. Lender 14 will typically transmit the record 428 to a lending processor 434. A portion of the borrower data 424, such as a social security number or mother's maiden name, is typically paired with the record 428 to insure the identity of the borrower 412 at an automated teller machine 436. As shown, lender 14 and lending processor 434 may be the same entity.

Borrower 12 can take the access code 432 to any automated teller machine 436 on the same network as lender 14 or lending processor 434 and request dispersal of the loan amount 430 by entering the access code 432. Access code 432 is typically entered through existing input means on the automated teller machine 436 such as a keypad or onscreen input field. Automated teller machine 436 may request additional data such as a portion of the borrower data 424 to verify borrower 12 identity. Automated teller machine 436 then transmits the access code 432 to an ATM processor 438. The ATM Processor 438 parses and validates the data 424 as described above with lending processor 434. If additional borrower data 424 has been collected, it is also transmitted to verify borrower 12 identity. Lending processor 434 responds to ATM Processor 438 with a loan amount 430 and then marks the record 428 as funded. ATM Processor 438 instructs Automated teller machine 436 to dispense the loan amount.

The primary advantage of the present invention is that borrower and lender do not have to be in the same location and borrower can retrieve funds nearly instantaneously after a funding decision has been made.

It should be apparent from the foregoing that an invention having significant advantages has been provided. While the invention is shown in only a few of its forms, it is not just limited but is susceptible to various changes and modifications without departing from the spirit thereof.

1. A fUnding system comprising:
a lending processor to approve a request for a loan from a borrower, to create a record that associates an amount of the loan with an access code, and to communicate the access code to the borrower remotely; and
an automated teller machine (ATM) to identify the borrower and to provide the loan amount without the use of a card, wherein the ATM comprises an input to accept the access code from the borrower.

2. The funding system according to claim 1 wherein:
the access code is in a format that is human readable and human replicable on a manual input device.

3. The funding system according to claim 1 wherein:
the ATM is in communication with the lending processor such that if the borrower enters the access code, the ATM confirms the amount of the loan with the lending processor.

4. The funding system according to claim 3 wherein:
the ATM dispenses an un-dispensed loan amount if the lending processor confirms the access code is associated with the un-dispensed loan amount.

5. The funding system according to claim 1 wherein:
the request for the loan is provided to the lending processor over a remote communication link.

6. The funding system according to claim 5 wherein:
the remote communication link comprises at least one of: a telephone, a facsimile, and a computer network.

7. The funding system according to claim 1 wherein:
the lending processor provides the access code to the borrower over a remote communication link.

8. The funding system according to claim 7 wherein:
the remote communication link is at least one of: a telephone, a facsimile, and a computer network.

9. A method for funding loans comprising:
processing data received from a borrower to determine if the borrower is approved for a requested loan;
if a lender approves the borrower for the requested loan, creating a record associating a loan amount with an access code;
transmitting the access code to the borrower in a format that is readable by the borrower;
using an automatic teller machine (ATM) to receive the access code and to verify the identity of the borrower without the use of a card; and
dispensing the loan amount using the ATM.

10. The method according to claim 9 wherein:
the access code is in a format that is human replicable on a manual input device.

11. The method according to claim 9 further comprising:
if the borrower enters the access code, using the ATM to confirm the loan amount.

12. The method according to claim 11 further comprising:
dispensing an amount of money less than the loan amount if the lending processor confirms the access code is associated with an un-dispensed loan amount.

13. The method according to claim 9 wherein:
the step of receiving the data from the borrower occurs over a remote communication link.

14. The method according to claim 13 wherein:
the remote communication link comprises at least one of: a telephone, a facsimile, and a computer network.

15. The method according to claim 9 wherein:
the step of transmitting the access code to the borrower occurs over a remote communication link.

16. The method according to claim 15 wherein:
the remote communication link is at least one of: a telephone, a facsimile, and a computer network.

17. A funding system comprising:
a lending processor to approve a request for a loan from a borrower, to create a record that associates an amount of the loan with an access code, and to communicate the access code to the borrower remotely and further associates a password with the access code and communicates the password to the borrower; and
an automated teller machine (ATM) to identify the borrower and to provide the loan amount without the use of a card, wherein the ATM comprises an input to accept the access code and the associated password from the borrower.

18. The funding system according to claim 17 wherein:
the approval of the request for the loan from the borrower is made without checking the credit history or credit reports of the borrower.

19. The funding system according to claim 17 wherein:
the loan amount is provided without requiring the borrower to have a bank account.

20. The funding system according to claim 17 wherein:
the password is in a format that is human readable and human replicable on a manual input device.
